(19) United States
(12) Patent Application Publication
(10) Pub. No.: US 2026/0336800 A1
(43) Pub. Date: Oct. 29, 2026

(54) ROTORCRAFT AND METHOD FOR REGULATING A VARIABLE ROTATION SPEED OF A ROTOR

(71) Applicant: AIRBUS HELICOPTERS, Marignane Cedex (FR)

(72) Inventor: Stéphane CERQUEIRA, Eguilles (FR)

(73) Assignee: AIRBUS HELICOPTERS, Marignane Cedex (FR)

(21) Appl. No.: 19/449,830

(22) Filed: Jan. 15, 2026

(30) Foreign Application Priority Data
Apr. 28, 2025 (FR) FR2504456

(51) Int. Cl. B64C 27/57; B64D 31/06

(52) U.S. Cl. CPC B64C 27/57; B64D 31/06

(57) ABSTRACT

A method of regulating a rotation speed of a rotor of a rotorcraft having at least two engines, the rotorcraft comprising a regulation system that regulates each engine as a function of at least one setpoint speed to be achieved by the rotor. During an asymmetric operating mode, the method comprises: i) determining the setpoint speed using the regulation system, by applying an alternative law that increases the setpoint speed with respect to a default law applicable during a collaborative mode, in the presence of a forward speed greater than a first threshold.

### CROSS REFERENCE TO RELATED APPLICATION

This application claims priority to French Patent Application No. FR 25 04456 filed on Apr. 28, 2025, the disclosure of which is incorporated in its entirety by reference herein.

### TECHNICAL FIELD

The present disclosure relates to a rotorcraft and to a method of regulating a variable rotation speed of a rotor.

### BACKGROUND

A rotorcraft may comprise a power plant setting in motion a rotor forming a rotary wing. For example, a helicopter comprises at least one main rotor contributing to its lift, and possibly also its propulsion.

The power plant may comprise a plurality of combustion engines, also referred to more simply as "engines", setting in motion a mechanical system that drives the rotation of the rotor. For example, the engines are mechanically connected to a power transmission gearbox setting in motion the rotor.

Such an engine may be a turboshaft engine comprising a gas generator and at least one working turbine setting in motion an output shaft of the turboshaft engine. This output shaft is then mechanically connected to the mechanical system.

According to another aspect, the rotorcraft comprises a regulation system, the main function of which is to control, via the fuel flow, the driving power delivered by each engine. The purpose of this regulation system may be to keep the rotation speed of the rotor of a rotorcraft equal to a predetermined setpoint value. Such a regulation system usually comprises an engine computer and one fuel metering device per engine, and various sensors.

For example, a helicopter is piloted, in particular, by acting on the pitch of the blades of a main rotor. An increase in this pitch tends to cause a deceleration in the rotational movement of the main rotor, the increase in the pitch also causing an increase in the lift of the main rotor, but also in the aerodynamic drag of this main rotor. In order to prevent the rotation speed of the main rotor from being unduly reduced, the power generated by the engines must then increase so as to keep the rotation speed of the main rotor substantially constant. Similarly, when the pitch of the blades decreases, the power delivered by the engines must be reduced.

Moreover, the regulating of the fuel flow must be controlled to avoid, for example, surging or flame-out of an engine.

For example, sensors measure the first rotational speed NTL of the working turbine of a turboshaft engine. Under such circumstances, a first value, corresponding to the value that the first rotation speed NTL must have in order for the rotation speed of the rotor to be equal to its setpoint, is determined. As a result, if the first rotation speed NTL is different from this first value, the computer generates commands to accelerate or decelerate the engine to reach the setpoint rotation speed of the main rotor. Under these conditions, an engine computer determines a second value, for example by using anticipation laws based on the collective pitch of the blades of the main rotor. This second value corresponds to the value that the second rotational speed NG of the moving members of the gas generator of the turboshaft engine must reach in order for the first rotational speed NTL to be equal to the first value.

A rotorcraft regulation system may be used in order to obtain a variable rotation speed of the rotor. Indeed, a significant variation in the rotation speed NR of a rotor is exploited, for example, to reduce noise pollution near the ground and/or improve performance. As an indication, the rotation speed of the main rotor may be controlled to be variable over a range of values potentially between 90% and 110% of a reference speed.

In particular, a known law of variation of the rotation speed NR of a rotary wing may specify a setpoint speed NR* equal to a maximum speed, for example of the order of 105% of the reference speed when the aircraft has an air speed below a first threshold. This first threshold is, for example, of the order of 50 knots (kts, one knot is equal to 1.852 kilometers per hour). This feature aims to optimize performance at low speed, and in particular when the rotorcraft is in a hovering position.

In addition, this known law defines a reference speed NR* equal to a minimum speed, for example of the order of 90% of the reference speed, when the aircraft has an air speed greater than a second threshold. This second threshold is, for example, of the order of 75 knots. This feature makes it possible, in particular, to limit the forces exerted on dynamic assemblies at high speed, and/or to limit noise pollution.

Finally, this known law defines a linear decrease in this setpoint speed NR* from the maximum speed to the minimum speed, when the aircraft has an air speed that increases from the first threshold to the second threshold.

Optionally, the minimum speed varies as a function of altitude in order to optimize the performance of the aircraft and/or to avoid reaching low rotor speeds with the engines at high altitude, the engine performance being poorer at low speed. For example, the regulation law may comprise a plurality of equations each associated with a range of altitudes.

On a conventional rotorcraft, a multi-engine power plant operates, except in the case of failure, in a cooperative operating mode wherein the engines each generate a driving power that jointly contributes to setting the mechanical system in motion. Such a law for regulating the rotation speed NR is then particularly efficient.

By contrast, a power plant may also optionally operate in an asymmetric operating mode by putting at least one of the combustion engines in standby mode. On a twin-engine rotorcraft, during the asymmetric operating mode, an active engine is regulated to ensure the rotation of a rotor by transmitting a non-zero driving power to the rotor via its power shaft. On the other hand, a passive engine is on standby so as not to transmit driving power to the rotor.

An engine in standby mode may be shut down by having a combustion chamber switched off. The combustion chamber of the passive engine is then no longer supplied with fuel, and on a turboshaft engine the rotating parts of the gas generator may or may not be set in motion by an electric machine. Alternatively, an engine in standby mode can operate in idle or super-idle mode, having a combustion chamber ignited and supplied with fuel, the engine in standby mode operating at very low rotation speed and transmitting no power to the rotary wing, with the active engine or engines providing the entire power supply. For example, the passive engine is in idle mode with a rotation speed of around 40% of its rated speed.

On a twin-engine rotorcraft, if the active engine fails then the rotorcraft is in a non-motorized autorotation phase for the time required to reactivate the standby engine. During this period of time, the pilot lowers the pitch of the blades of the rotary wing to limit the drop in the rotation speed NR of the rotary wing and reach a setpoint speed.

Documents FR3061142 and FR3027124 are known, but are far removed from this problem. Document FR3061142 describes a device for regulating the rotation speed of a gas generator shaft of a rotorcraft turboshaft engine. Document FR3027124 describes a method for regulating the speed at which a rotorcraft rotor is driven under icing conditions.

Document EP 3 803 082 B1 describes a power plant provided with a first turboshaft engine and a second turboshaft engine. The first turboshaft engine is equipped with a heat exchanger. On the other hand, a computer limits the acceleration and deceleration capacity of the first turboshaft engine in order to limit the mechanical and thermal stresses exerted on the heat exchanger. The first turboshaft engine may be operated at a near constant power level in order to provide a portion of the propulsive energy required by an aircraft. In the event of a failure of the first turboshaft engine, the second turboshaft engine takes over and delivers all the necessary power. In the event of a failure of the second engine, the acceleration and deceleration capacity of the first turboshaft engine is no longer limited.

Documents US 2022/306308 A1, US 2020/362754 A1, and US 2022/106913 A1 are also known.

### SUMMARY

Therefore, one object of the present disclosure is to propose an innovative method and rotorcraft for optimizing this autorotation phase following the failure of the active engine during the application of the asymmetric operating mode.

The disclosure thus relates to a method for regulating a rotation speed of a rotorcraft rotor. The rotorcraft comprises a power plant having at least two engines and a power transmission system driving the rotation of the rotor, each engine having a power assembly connected to the power transmission system, the rotorcraft comprising a regulation system that regulates each engine as a function of at least one setpoint speed to be achieved by the rotor, the regulation system regulating, during an asymmetric operating mode at an active speed, at least one active engine among the at least two engines and putting at least one passive engine among the at least two engines on standby. The regulation system regulates said engines at an active speed during a collaborative operating mode, the regulation system determining said at least one setpoint speed during the collaborative operating mode by applying a default law giving said setpoint speed at least as a function of a forward speed of the rotorcraft, said setpoint speed being equal to a minimum value when said forward speed is greater than a first threshold.

During the asymmetric operating mode, the method comprises: i) determining the setpoint speed using the regulation system, by applying an alternative law generating a setpoint speed greater than the setpoint speed generated by the default law in the presence of a forward speed greater than the first threshold and at the same altitude, and ii) regulating said active engine to reach the setpoint speed.

In particular, each engine may be a turboshaft engine, each power assembly comprising at least one expansion turbine and at least one power shaft.

According to one example, the regulation system can determine the setpoint speed to be achieved by the rotor, and deduce therefrom a target rotation speed to be achieved by a member of each power assembly. The regulation system then regulates the engines in the usual manner.

In addition, the regulation system applies a default law during the collaborative operating mode, this default law being at least a function of the forward speed of the aircraft, and possibly also of its altitude. Each engine is controlled to operate at an active speed in order to produce a driving power contributing to the rotation of the rotor in order that the setpoint speed is reached.

When the collaborative operating mode is engaged, all the engines therefore develop a driving power. The failure of one of the engines is compensated by the other engine. Consequently, the rotation speed of the rotor is hardly affected, if at all, by the failure of an engine, even at high speed when the setpoint speed is minimized.

On the other hand, during the asymmetric operating mode, the regulation system regulates at least one active engine among the at least two combustion engines at an active speed, and puts at least one passive engine among the at least two combustion engines on standby, the active engine developing with its power shaft a non-zero driving power participating in the rotation of the rotor, the passive engine transmitting no power to the rotor.

When the asymmetric operating mode is active, the rotor is therefore set in motion by the one or more active rotors, and in particular by a single active engine on a twin-engine aircraft. If the active engine fails, the rotor is no longer driven in rotation by an engine during the short period of time necessary to reactivate the passive engine. The pilot then engages an autorotation procedure to limit the decrease in the rotation speed of the rotor while the passive engine is reactivated. However, at high speed, the default law conventionally requires regulation of the rotation speed of the rotor at a minimum speed. Therefore, the rotation speed of the rotor may approach an acceptable low limit during the period of time necessary to reactivate the passive engine.

The disclosure makes it possible to remedy this problem. Indeed, when the asymmetric operating mode is active and at high forward speed, then the setpoint speed to be reached is greater, in at least one range of altitudes, than the setpoint speed to be reached when the collaborative operating mode is active and under the same conditions, namely at the same speed and at the same altitude. As a result, the alternative law makes it possible to obtain a greater margin relative to the permissible limit rotation speed for the rotor when the asymmetrical operating mode is activated.

Therefore, this method enables the advantages associated with the use of a usual default law during the collaborative operating mode to be retained, while guaranteeing a sufficient safety margin when the asymmetric operating mode is active.

The method may further comprise one or more of the following features, taken individually or in combination.

According to one possibility, for a forward speed less than a second threshold, the second threshold being less than the first threshold, the setpoint speed can be equal to a same maximum value according to the default law and the alternative law.

The maximum value is greater than the setpoint value reached in the presence of a forward speed greater than the first threshold, both with the default law and with the alternative law. In other words, at low speed, the default law and the alternative law provide the same maximum value for the setpoint speed. This feature aims to reach the same maximum value, in particular to obtain the required performance during a hovering phase.

According to one possibility compatible with the preceding possibilities, for a forward speed greater than the first threshold, the setpoint speed can be equal to a minimum value according to the default law and the alternative law, the minimum value taking a first value according to the default law and a second value according to the alternative law, the second value being greater than the first value at the same altitude.

The first value and the second value are both less than the aforementioned maximum value. Thus, at high speed, the setpoint speed takes a minimum value that is higher, under identical conditions, namely for the same altitude, when applying the asymmetric operating mode, than during the collaborative operating mode.

Optionally, said first value and second value may vary as a function of altitude.

This feature makes it possible to optimize the operation of the power plant by taking the altitude into consideration. This altitude may be a density altitude or a pressure altitude. The density altitude corresponds to the pressure altitude corrected for the effect of temperature. The pressure altitude is calculated in the usual way from, for example from atmospheric pressure measured using a barometer or the like. On the other hand, the density altitude is calculated in the usual way from, for example from atmospheric pressure, measured using a barometer or the like, and a temperature measured using a thermocouple or other temperature sensing elements.

According to one possibility compatible with the preceding possibilities:
when the asymmetric operating mode is activated, the method may comprise regulating the active engine by linearly varying the setpoint speed from the first value to the second value; and
when the asymmetric operating mode is deactivated, the method may comprise regulating the engines by linearly varying the setpoint speed from the second value to the first value.

These features make it possible to obtain an optimized transition during the transition from the collaborative operating mode to the asymmetric operating mode, and vice versa.

According to one possibility compatible with the preceding possibilities, for a forward speed greater than or equal to the second threshold and less than or equal to the first threshold, the setpoint speed can decrease linearly from the maximum value to the minimum value according to the default law and the alternative law.

In addition to a method, the disclosure also relates to a rotorcraft, said rotorcraft comprising a power plant having at least two engines and a power transmission system driving the rotation of the rotor, each engine having a power assembly connected to the power transmission system, the rotorcraft comprising a regulation system that regulates each engine as a function of at least one setpoint speed to be reached by the rotor, the regulation system regulating at least one active engine among the at least two engines during an asymmetric operating mode at an active speed and putting at least one passive engine among the at least two engines on standby, the regulation system regulating said engines at an active speed during a collaborative operating mode, the regulation system determining, during the collaborative operating mode, said at least one setpoint speed by applying a default law giving said setpoint speed at least as a function of a forward speed of the rotorcraft, said setpoint speed being equal to a minimum value when said forward speed is greater than a first threshold.

The regulation system is configured to implement the method of the disclosure.

According to one possibility, the regulation system may comprise a speed sensor measuring a forward speed of the rotorcraft.

For example, the speed sensor may measure the true air speed, or a ground speed.

According to one possibility, the regulation system may comprise an altitude sensor measuring an altitude.

The term sensor used hereinafter may designate an assembly comprising one or more sensing elements, and possibly also a computer.

Thus, the altitude sensor may comprise a barometer for evaluating a pressure altitude or a barometer and a thermocouple or other type of temperature sensing element for evaluating a density altitude.

### BRIEF DESCRIPTION OF THE DRAWINGS

The disclosure and its advantages appear in greater detail from the following description of examples given by way of illustration with reference to the accompanying figures, wherein:

FIG. 1 is a diagram illustrating a rotorcraft according to the disclosure;

FIG. 2 is a diagram illustrating the method of the disclosure; and

FIG. 3 is a diagram illustrating the method of the disclosure.

### DETAILED DESCRIPTION

Elements present in more than one of the figures are given the same references in each of them.

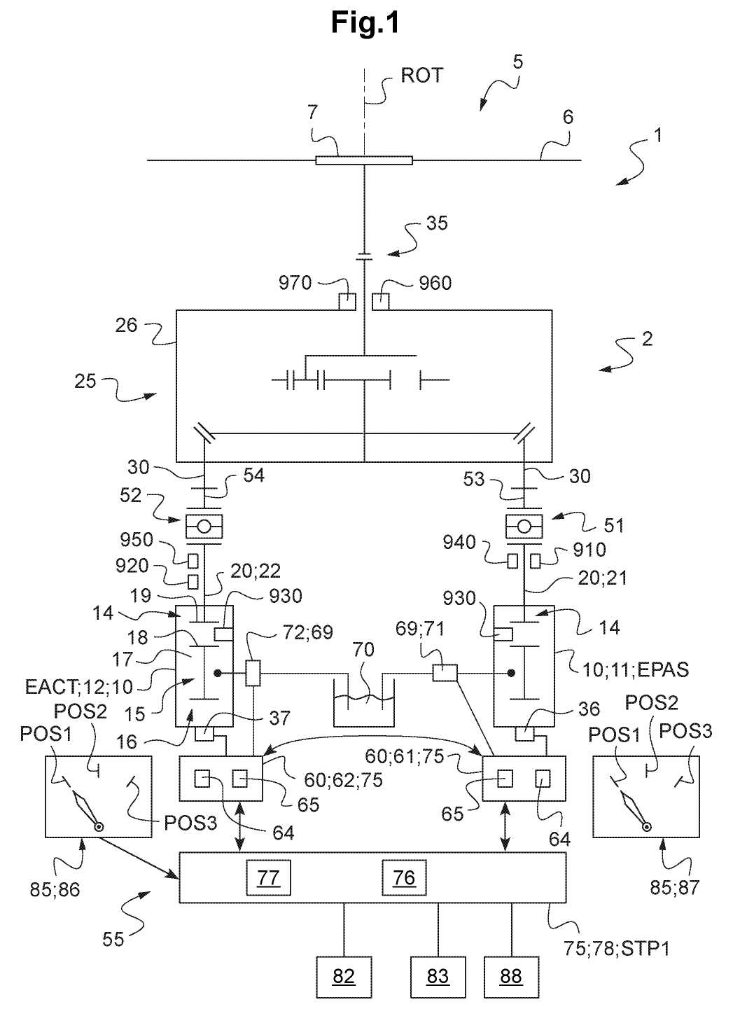

FIG. 1 shows an example of a rotorcraft 1 according to the disclosure. This rotorcraft 1 comprises a rotor 5. This rotor 5 is provided with a plurality of blades 6 that can rotate about an axis ROT relative to a fuselage and may be supported by a hub 7 or equivalent. For example, the rotor 5 forms a rotary wing.

The rotorcraft 1 has a power plant 2 for rotating the rotor 5. This power plant 2 is provided with at least two engines 10. Reference sign 10 designates any engine, and reference signs 11 and 12 designate specific engines if necessary.

According to one example, at least one engine 10 may be a turboshaft engine. Such a turboshaft engine 10 comprises a gas generator 15 that is equipped with at least one compression turbine 16, at least one combustion chamber 17 into which the fuel is injected and at least one expansion turbine 18 constrained to rotate with the one or more compression turbines 16. Moreover, the turboshaft engine 10 may comprise a power assembly 14 having at least one working turbine 19 that directly or indirectly sets a power shaft 20 of the engine 10 in motion. Reference sign 20 designates any power shaft, references 21, 22 denoting particular power shafts of the two engines 11, 12 respectively.

Irrespective of the type of engines, each engine 10 therefore comprises a power assembly 14 connected to a power transmission system 25. The power transmission system 25 is then connected to the rotor 5 in the usual way.

By way of illustration, the power transmission system 25 may be provided with a power transmission gearbox 26 that is mechanically interposed between the engines 10 and the rotor 5. The power transmission gearbox 26 may be provided with one input shaft 30 for each engine 10 and various gears arranged between the input shafts 30 and the rotor mast 35 secured to the hub 7.

The power transmission system 25 may comprise at least one freewheel 51, 52, for example between each engine 10 and the power transmission gearbox 26, and/or at least one connecting shaft 53, 54, and/or at least one connector allowing misalignments. The literature describes various types of power transmission gearboxes and various mechanical drive trains, the example described being given solely by way of illustration.

Furthermore, the engines 10 are combustion engines that run on fuel and can be started by starters 36, 37. The rotorcraft 1 therefore comprises a regulation system 55 for controlling the starters 36, 37 and the power output by each engine 10 via its power shaft 20.

Thus, the regulation system 55 comprises one fuel metering device 69 per engine 10. Each engine 10 is then connected via its own fuel metering device 69 to at least one fuel tank 70. Reference sign 69 denotes any fuel metering device and reference signs 71, 72 denote particular fuel metering devices of the two engines 11, 12 respectively.

The regulation system 55 may comprise one regulation unit per engine 10, such as an FADEC (Full Authority Digital Engine Control). Each regulation unit comprises one engine computer 60 per engine 10. Each engine computer 60 may comprise a processing unit. Such a processing unit may have, for example, at least one processor 64 and at least one memory 65, at least one integrated circuit, at least one programmable system, or at least one logic circuit, these examples not limiting the scope to be given to the term "processing unit". The engine computers 60 can communicate with each other via wired or wireless links.

According to the described example, the regulation system 55 comprises two engine computers 61, 62 controlling two engines 11, 12 respectively. Each engine computer 60 is configured to control the associated engine 10 and operate it at the required speed. In particular, each engine computer 61, 62 can control the fuel metering device 71, 72 of this engine 11, 12. Each engine computer 61, 62 can be connected to multiple sensors in order to control the associated engine 11, 12, such as, for example, a temperature sensor 930 measuring the gas temperature for example at the inlet of a free turbine, a speed sensor measuring for example the rotation speed of a gas generator 15 of the turboshaft engine 10, a torque meter 910, 920 measuring an engine torque on a rotating member of the power assembly, a speed sensor 940, 950 measuring, for example, the rotation speed of this rotating member, a torque meter 960 measuring a torque exerted on the rotor mast 35, a speed sensor 970 measuring, for example, the rotation speed of this rotor mast 35, a sensor measuring the outside pressure, a sensor measuring the outside temperature, etc.

The term "sensor" should be understood to mean a physical sensing element capable of directly measuring the parameter in question, but also a system that may comprise one or more physical sensing elements, as well as means for processing the signal, making it possible to provide an estimation of the parameter based on the measurements provided by these physical sensing elements. Similarly, the notion of measuring parameters refers to both a raw measurement from a physical sensing element and a measurement obtained by relatively complex processing of raw measurement signals.

The engine computers 60 can form a controller 75 applying the method of the disclosure, or a management computer 78 of the regulation system 55 can act as a controller 75.

If necessary, the management computer 78 may be a computer known by the acronym AMC and the expression "Aircraft Management Computer". The management computer 78 may comprise at least one processing unit, for example. The management computer 78 can communicate via wired or wireless links with each engine computer 60. The management computer 78 can communicate with each of the above-mentioned measurement systems, either directly or via an engine computer 60.

In addition, the controller 75 can communicate with at least one human-machine piloting interface 85, or with one human-machine piloting interface 85 per engine 10, i.e., two interfaces 86, 87 according to the example given. Each human-machine piloting interface 85 can, for example, emit a signal carrying a stop command, an idle speed command or a flight speed command for the engine 10 concerned. FIG. 1 shows the interfaces in three-positions stop POS1/idle POS2/flight POS 3 used for this purpose.

In addition, the controller 75 can communicate with a human-machine control interface 88 that can be manipulated to activate or deactivate the asymmetric operating mode manually.

Each human-machine interface 85, 88 may comprise a device that can be operated by a pilot, such as a button or a lever for example, a touch screen, a voice command, etc. According to the example shown, the human-machine interfaces 85, 88 communicate with the management computer 78. Alternatively or additionally, the human-machine interfaces 85, 88 communicate with one or each engine computer unit 60.

Furthermore, the controller 75 can communicate, directly or indirectly, with one or more of the following sensors:
a speed sensor 82 measuring a current forward speed Vcur of the rotorcraft 1, and for example a true air speed or a ground speed, such a speed sensor 82 being able to comprise a satellite positioning system and/or a Pitot tube system, for example; and
an altitude sensor 83 measuring an altitude, such as a sensor comprising a sensing element measuring the pressure of the air surrounding the rotorcraft 1, and possibly also a temperature sensing element.

For example, an AMC computer acquires the measurements from the aforementioned one or more sensors, and communicates them to the engine computers 60.

Under these conditions, the regulation system 55 is configured to regulate the driving power developed by each engine 10 by applying the regulation method of the disclosure. In particular, the controller is configured to apply the method of the disclosure, in order that the regulation system 55 controls the fuel metering device 69 of each engine 10 so that the rotor 5 is set in motion at a setpoint rotation speed.

For this purpose, the regulation system 55, and in particular the controller 75, controls the fuel metering device 69 of each engine 10 so that a setpoint speed Vcons of the rotor 5 is reached.

Independently of this aspect, during a collaborative operating mode, each engine 10 is a so-called active engine that is regulated by the regulation system 55 to output, via its power shaft 20, a non-zero active driving power that contributes to the rotation of the rotor 5. For example, the first human-machine piloting interface 86 is placed in the position POS3 and transmits a control signal to the engine computer 61. Similarly, the second human-machine piloting interface 87 is placed in position POS3 and transmits a control signal to the engine computer 62.

During the collaborative operating mode, the regulation method comprises measuring the current forward speed Vcur using the speed sensor 82, and possibly also an altitude of the aircraft using the altitude sensor 83.

The controller 75 determines the setpoint speed Vcons by then applying a stored default law Lawdef as a function of the current forward speed Vcur and possibly also said altitude. The regulation system then regulates all the engines so that the rotation speed of the rotor tends towards the setpoint speed Vcons.

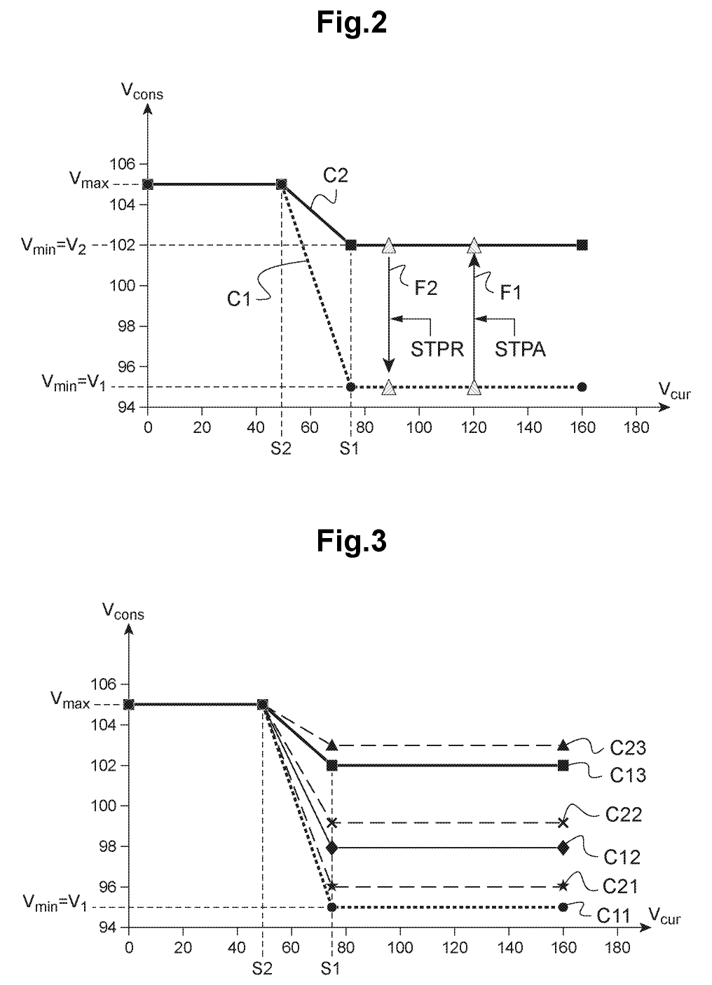

According to the example shown, the management computer 78 applies, at each instant, a regulation law to determine the setpoint speed Vcons only as a function of the current forward speed measured using the speed sensor 82 according to the example of FIG. 2 and possibly also as a function of the altitude measured using the altitude sensor 83 according to the example of FIG. 3. The management computer 78 or the engine computers 60 deduce therefrom, in a conventional manner, for example by means of stored control laws, speed setpoints NTL* for the rotation speed NTL of the power assembly of each engine 10. The engine computers 60 then servo-control the fuel metering devices of the engines 10 to cause the rotation speeds NTL measured using the speed sensors 940, 950 to tend towards the setpoint speeds of rotation NTL*.

In order to activate the asymmetric operating mode, a pilot can operate the human-machine control interface 88 during a preliminary step.

During the asymmetric operating mode, the regulation system 55 keeps at least one of the engines, known as the "active engine EACT", active and puts at least one of the engines, known as the "passive engine EPAS", in standby mode. The one or more passive engines EPAS are then either shut-down by the one or more engine computers concerned, by having a combustion chamber switched off, optionally with at least one compressor and one turbine of the gas generator in motion, or idled so as not to transmit driving power via the associated freewheel 51, 52.

Then, the regulation method comprises measuring the current forward speed Vcur using the speed sensor 82, and possibly also an altitude of the aircraft using the altitude sensor 83.

Moreover, this method comprises determining, during a step STP1 and using the regulation system 55, or the controller 75 and possibly with the management computer 78 if applicable, the setpoint speed Vcons by applying an alternative law lawasy that increases the setpoint speed relative to the default law Lawdef when the forward speed Vcur is greater than the first threshold S1 and for the same altitude.

Then, the method comprises regulating, during a step STP2 and using the regulation system 55, or the controller 75 and possibly using the corresponding engine computer 60, of the active engine EACT to reach the setpoint speed Vcons.

According to the preceding example, the management computer 78 applies, at each instant, a regulation law to determine the setpoint speed Vcons, to the management computer 78 or the engine computer 60 of the active engine by deducing a speed setpoint NTL* for the rotation speed NTL of the power assembly of the active engine. The engine computer 60 then servo-controls the fuel metering devices of the active engine to cause the rotation speeds NTL measured using the associated speed sensors to tend towards the setpoint speed of rotation NTL*.

FIG. 2 shows a diagram giving the setpoint speed Vcons of the rotor 5 as a function of the forward speed Vcur measured using the speed sensor 82. The setpoint speed Vcons is expressed as a percentage of a reference rotation speed, and the forward speed Vcur is expressed in knots (kts).

Curve C1 illustrates the default law and curve C2 the alternative law.

According to FIG. 2, the default law Lawdef specifies that the setpoint speed is equal to:
a maximum value Vmax for a forward speed Vcur less than a second threshold S2, the second threshold S2 being less than the first threshold S1;
a minimum value Vmin equal to a first value V1 for a forward speed Vcur greater than the first threshold S1; and
a value that decreases linearly from the maximum value Vmax to the first value V1 for a forward speed Vcur that increases from the second threshold S2 to the first threshold S1.

Therefore, the alternative law specifies that the setpoint speed Vcons is equal to a minimum value Vmin equal to a second value V2 in the presence of a forward speed Vcur greater than the first threshold S1, the second value V2 being greater than the first value V1. This feature makes it possible to move the rotation speed of the rotor 5 away from a low limit.

Optionally, the alternative law specifies that the setpoint speed Vcons is equal to

the maximum value Vmax for a forward speed Vcur below the second threshold S2; and

a value that decreases linearly from the maximum value Vmax to the second value V2 for a forward speed Vcur that increases from the second threshold S2 to the first threshold S1.

When the asymmetric operating mode is activated, the method may comprise regulating STPA the active engine EACT by linearly varying the setpoint speed from the first value V1 to the second value V2, corresponding to the arrow F1.

On the other hand, when the asymmetric operating mode is deactivated, the method may comprise regulating STPR the engines 10 by linearly varying the setpoint speed from the second value V2 to the first value V1, corresponding to the arrow F2.

According to another aspect, each law may take the form of one or more equations implemented by the controller 75.

In addition, according to FIG. 2, the first value V1 and the second value V2 are fixed.

Consequently, according to the method illustrated in FIG. 2, the method comprises measuring, using the controller 75, the current forward speed Vcur using the speed sensor 82, then determining the setpoint speed using the controller as a function of this current forward speed Vcur, using the default law during the collaborative operating mode and the alternative law during the asymmetric operating mode, then regulating each active engine as a function of this setpoint speed Vcons.

Conversely, FIG. 3 illustrates another variant for which the minimum value Vmin varies as a function of the altitude or a range of altitudes.

Thus, the first value V1 and the second value V2 depend on the altitude.

The method then comprises measuring, using the controller 75, the current altitude using the altitude sensor 83 and the current forward speed Vcur using the speed sensor 82, and determining the setpoint speed Vcons as a function of the current altitude and the current forward speed, using the default law during the collaborative operating mode and the alternative law during the asymmetric operating mode, and then regulating each active engine as a function of this setpoint speed Vcons.

FIG. 3 illustrates a default law taking the form of three curves C11, C12, C13 for three altitude ranges, and an alternative law comprising three respective curves C21, C22, C23.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A method of regulating a rotation speed of a rotor of a rotorcraft, the rotorcraft comprising a power plant having at least two engines and a power transmission system driving the rotation of the rotor, each engine having a power assembly connected to the power transmission system, the rotorcraft comprising a regulation system that regulates each engine as a function of at least one setpoint speed to be reached by the rotor, the regulation system regulating at least one active engine among the at least two engines during an asymmetric operating mode at an active speed and putting at least one passive engine among the at least two engines on standby, the regulation system regulating the engines at an active speed during a collaborative operating mode, the regulation system determining, during the collaborative operating mode, the at least one setpoint speed by applying a default law giving the setpoint speed at least as a function of a forward speed of the rotorcraft, the setpoint speed being equal to a minimum value when the forward speed is greater than a first threshold,
wherein during the asymmetric operating mode, the method comprises: i) determining the setpoint speed using the regulation system, by applying an alternative law generating a setpoint speed greater than the setpoint speed generated by the default law in the presence of a forward speed greater than the first threshold and at the same altitude, and ii) regulating the active engine to reach the setpoint speed.

2. The method according to claim 1,
wherein for a forward speed less than a second threshold, the second threshold being less than the first threshold, the setpoint speed is equal to a same maximum value according to the default law and the alternative law.

3. The method according to claim 2,
wherein for a forward speed greater than or equal to the second threshold and less than or equal to the first threshold, the setpoint speed decreases linearly from the maximum value to the minimum value according to the default law and the alternative law.

4. The method according to claim 1,
wherein for a forward speed greater than the first threshold, the setpoint speed is equal to the minimum value according to the default law and the alternative law, the minimum value taking a first value according to the default law and a second value according to the alternative law, the second value being greater than the first value at the same altitude.

5. The method according to claim 4,
wherein the first value and the second value vary as a function of altitude.

6. The method according to claim 4,
wherein:
when the asymmetric operating mode is activated, the method comprises regulating the active engine by linearly varying the setpoint speed from the first value to the second value; and
when the asymmetric operating mode is deactivated, the method comprises regulating the engines by linearly varying the setpoint speed from the second value to the first value.

7. A rotorcraft, the rotorcraft comprising a power plant having at least two engines and a power transmission system driving the rotation of the rotor, each engine having a power assembly connected to the power transmission system, the rotorcraft comprising a regulation system that regulates each engine as a function of at least one setpoint speed to be reached by the rotor, the regulation system regulating at least one active engine among the at least two engines during an asymmetric operating mode at an active speed and putting at least one passive engine among the at least two engines on standby, the regulation system regulating the engines at an active speed during a collaborative operating mode, the regulation system determining, during the collaborative operating mode, the at least one setpoint speed by applying a default law giving the setpoint speed at least as a function of a forward speed of the rotorcraft, the setpoint speed being equal to a minimum value when the forward speed is greater than a first threshold,
wherein the regulation system is configured to implement the method according to claim 1.

8. The rotorcraft according to claim 7,
wherein the regulation system comprises a speed sensor measuring a forward speed of the rotorcraft.

9. The rotorcraft according to claim 7,
wherein the regulation system comprises an altitude sensor measuring an altitude.
